(19) United States
(12) Patent Application Publication
(10) Pub. No.: US 2026/0127491 A1
(43) Pub. Date: May 7, 2026

(54) Device for Training, in Particular Continuously, a Machine Learning Model

(71) Applicant: Robert Bosch GmbH, Stuttgart (DE)

(72) Inventors: Mingyang Wang, Muenchen (DE); Heike Adel-Vu, Renningen (DE); Lukas Lange, Pforzheim (DE)

(21) Appl. No.: 19/196,119

(22) Filed: May 1, 2025

(30) Foreign Application Priority Data
Nov. 4, 2024 (DE) 20 2024 106 283.3

(51) Int. Cl. G06N 20/00

(52) U.S. Cl. CPC G06N 20/00

(57) ABSTRACT

A device for training, in particular continuously, a machine learning model is disclosed. The device includes an evaluation and computing device that is designed to perform the following steps (i) providing trainable task feature vectors and associated, pre-known task modules for a selection of pre-known tasks from a data pool containing data on tasks that have been solved using the pre-known task modules of the machine learning model, (ii) providing a task input embedding, a trainable task module with an associated trainable task feature vector for a task input to be solved, (iii) calculating comparison weights between the task input embedding and the trainable task feature vectors to form a weighted sum, in particular a temporary weighted sum, from the task modules and the comparison weights, (iv) combining the weighted sum with the machine learning model, and (v) training the machine learning model to solve the task input by training the task feature vector and the task module depending on a training criterion.

This application claims priority under 35 U.S.C. § 119 to patent application no. DE 20 2024 106 283.3, filed on Nov. 4, 2024 in Germany, the disclosure of which is incorporated herein by reference in its entirety.

The disclosure relates to a device for training a machine learning model, in particular continuously.

### BACKGROUND

Machine learning should be based on a continuous learning approach in order to evolve continuously and remain effective over time.

There are three particular challenges to continuous learning: On the one hand, forgetting what has already been learned should be avoided, i.e., newly acquired information should not interfere with or impair previously acquired knowledge. Furthermore, knowledge transfer should be facilitated, i.e., knowledge gained from previous tasks should be reused for the efficient learning of new tasks.

Parameter efficiency should also be maintained, i.e., machine learning models must remain lightweight and effective even when the continuous learning sequence scales to hundreds of tasks.

To address these challenges, previous work has employed the idea of parameter isolation and parameter-efficient fine-tuning for continuous learning. Despite its effectiveness in terms of performance in continuous learning tasks, the progressive expansion of task-specific parameters, when the tasks in a continuous learning sequence number in the hundreds, leads to parameter efficiency and significantly increases computing and memory costs.

It is an object of the disclosure to provide an improved device.

The task is solved by a device according to the features set forth below.

### SUMMARY

According to a first aspect, a device for training a machine learning model, in particular continuously, is proposed, wherein the device comprises an evaluation and computing device that is designed to perform the following steps:
providing trainable task feature vectors v₀ . . . Vₘ₋₁ and associated, pre-known task modules P₀ . . . Pₘ₋₁ for a selection of pre-known tasks from a data pool containing data on tasks that have been solved using the pre-known task modules P₀ . . . Pₘ₋₁ of the machine learning model;
providing a task input embedding Xₙ, a trainable task module Pₘ with an associated trainable task feature vector vₘ for a task input Tₙ to be solved;
calculating comparison weights α₁ . . . αₘ between the task input embedding (xₙ) and the trainable task feature vectors v₀ . . . vₘ to form a weighted sum P′ₘ, in particular a temporary weighted sum, from the task modules P₀ . . . Pₘ and the comparison weights α₁ . . . αₘ;
combining the weighted sum P′ₘ with the machine learning model; and
training the machine learning model to solve the task input Tₙ by training the task feature vector vₘ and the task module Pₘ depending on a training criterion.

It is understood that the steps according to the disclosure and further optional steps do not necessarily have to be carried out in the order shown, but may also be carried out in a different order. Furthermore, intermediate steps may also be provided. The individual steps may also comprise one or more sub-steps without departing from the scope of the disclosure.

In this paper, we propose a machine learning model that follows a continuous learning approach (also referred to as MoCL-P for short). This machine learning model offers a lightweight approach to continuous learning that uses task-oriented module composition and adaptive thinning to address the three challenges of continuous learning mentioned above, either in whole or in part. The machine learning model and the associated method are not only characterized by their high performance, but also surpass previous algorithms in terms of parameter efficiency many times over, as demonstrated by a corresponding benchmark. MoCL-P proposes a sustainable path for continuous learning so that models remain simple and effective even as they evolve with increasing tasks and continue to evolve as tasks increase.

The present device proposes a solution for parameterized, isolated, continuous learning. In this process, task-specific parameters are assigned to each task in the continuous learning sequence. Each task-specific module is preferably “frozen” as soon as training for a specific task is complete, thus preventing catastrophic forgetting, as the knowledge in the respective specific module is retained for the subsequent training process. Furthermore, the present approach features modular and compositional learning and ensures that the machine learning model exhibits effective knowledge transfer through the reuse of relevant knowledge from previous tasks.

In addition, there may be a set of parameters that is used for all tasks. These make up the majority of the parameters and have been pre-trained (such as BERT or DINO). These are also frozen. The task-specific modules are then inserted between the existing layers.

The present disclosure can be used to analyze data of various types that can be represented with vector representations (embeddings), such as text and/or image data. The disclosure can be used in real-world applications for continuous learning where new tasks are constantly being learned, especially when minimal resource requirements are needed. This may involve sample tasks such as natural language processing (NLP) or computer vision.

An example of natural language processing could be the analysis of patent documents. Over time, the areas covered by patent documents may change or new areas may be added. The NLP algorithms used to analyze patents must be able to adapt to these changes in order to ensure a sufficiently good analysis over time. In this case, a good algorithm for continuous learning is crucial. On the one hand, the underlying machine learning model should not forget what it has learned when adjustments are made. On the other hand, existing knowledge should be used so that the machine learning model can quickly adapt to new text and/or image classifications with changing labels and/or a stream of new input texts and/or image data.

Another area may involve the processing of knowledge in a knowledge database, whose set of labels grows naturally as the knowledge content increases. The method can also be applied to assistance systems based on (large) language models, as these systems need to continuously adapt to new tasks or languages. The present disclosure is a method for continuously learning new knowledge without forgetting existing knowledge, while efficiently balancing and adjusting knowledge integration and computational effort.

Continuous learning examines the problem of learning from an infinite stream of data with the aim of gradually expanding the knowledge acquired and using it for future learning. Our disclosure addresses the central challenges of “catastrophic” forgetting, knowledge transfer, and parameter efficiency in continuous learning, thus providing a scalable and efficient solution for real-world scenarios where low resource requirements are critical.

In contrast to the complete isolation of task-specific parameters in continuous learning, which precludes knowledge transfer, the present approach follows the idea of introducing a combination of task modules to facilitate knowledge transfer. To this end, task representations will be used for matching task modules and, consequently, for combining old and new modules for learning. Module matching aims to determine the contribution of each existing module to learning the current task, i.e., the extent to which previously learned modules can be reused for the current task.

Trainable feature vectors V ε RN×D are introduced as task representations in order to capture the features of each task in the continuous learning sequence. In this process, the dimension of each task feature vector v εRD is set to the same value as the dimension of the input embeddings xₙ ε RD.

Starting from a set of selected modules {P₀, . . . , Pₘ₋₁} from previous tasks and a new task Tₙ, wherein preferably: m−1«n, a trainable module Pₘ is initialized and preferably at least temporarily added to the model. For each instance xⁱₙ the current task Tₙ, the appropriate weights {α₀, . . . , αₘ} are calculated, in particular by comparing xₙ with all task feature vectors {v₀, . . . , vₘ} from our current set of modules. In particular, the cosine similarity between xₙ and {v₀, . . . , vₘ} is calculated as modulus matching weights α_{0:m}. The new and old modules are then combined using a weighted sum:

$${P}_{m}^{′} = {\sum }_{k = 0}^{m} {α}_{k} {P}_{k}$$

Finally, the composite module Pₘ′ is combined with the machine learning model, which consists in particular of all selected module components up to the current task.

In a further aspect, it is proposed that after training the machine learning model to solve the task input Tₙ, the comparison weight αₘ of the task module Pₘ is compared with a predefined threshold value, wherein the comparison is used to determine whether the task module Pₘ should be removed from the weighted sum of task modules P₀ . . . . Pₘ or remain included therein.

The need for efficiency increases significantly when the continuous learning sequence is scaled up to dozens or hundreds of tasks. The continuous expansion of the module pool to assign a PEFT module to each task, as carried out in previous work (Wang et al., 2023d; Razdaibiedina et al., 2022; Wang et al., 2024), leads to high computational costs. In contrast, in the present case, an adaptive pruning strategy is preferably used to make the approach scalable for scenarios with long task sequences. In particular, our pruning strategy aims to retain only those modules that add new and valuable information to the modules already selected.

After completing the training on Tₙ (in particular the training on the PEFT module Pₘ and the task feature vector vₘ), αₘ, i.e., the comparison weight of the new module Pₘ, is compared with a threshold value to decide whether Pₘ should be removed or left in the group of existing modules. The idea here is that a high weighting indicates new and valuable information, while task modules with a low weighting do not contribute any new information and can therefore be discarded.

In a further aspect, it is proposed that training the machine learning model to solve the task input Tₙ involves finding the task module Pₘ and the task feature vector vₘ that minimize a loss of cross-entropy of training examples and simultaneously maximize a cosine similarity between the task-specific task feature vector vₘ and the corresponding task input embedding xₙ.

The training objective for the nth task in the continuous learning sequence is to find the task module Pₘ and the task feature vector vₘ that minimize the entropy loss of the training examples while maximizing the cosine similarity between the task-specific feature vector vₘ and the corresponding task input embeddings xₙ:

$${min}_{{P}_{m} , {v}_{m}} - {\sum }_{{x}_{n} , {y}_{n}} log p ( {y}_{n} \vert {x}_{n} , {P}_{n}^{′} , θ ) - {\sum }_{{x}_{n}} cos ( {x}_{n} , {v}_{m} )$$

This is

$${P}_{m}^{′} = {\sum }_{k = 0}^{m} {α}_{k} {P}_{k}$$

the weighted sum of the new trainable task module and the existing frozen task modules. During inference, a task module matching and composition is performed for each instance. The resulting module is preferably combined with the machine learning model for inference.

In a further aspect, it is proposed that the machine learning model comprises a language model, in particular a large language model such as a vision transformer or a convolutional neural network.

In principle, other machine learning models are also conceivable.

In a further aspect, it is proposed that calculating the comparison weight α₁ . . . αₘ involves calculating the cosine similarity between the task input embedding xₙ, and the trainable task feature vectors v₀ . . . vₘ.

In the present case, a cosine similarity between the input embeddings xₙ and each feature vector vᵢ up to the current task is preferably calculated as a matching score αᵢ=cos(xₙ, vᵢ). Consequently, the module matching weights {α₀, α₁, . . . } for module composition are obtained in order to reuse existing knowledge.

In a further aspect, it is proposed that the task modules P₀ . . . . Pₘ each have parameter-efficient fine-tuning parameters (PEFT).

In this work, we use the idea of parameter isolation with parameter-efficient fine-tuning (PEFT), which was introduced in previous work (Razdaibiedina et al., 2022; Wang et al., 2023c,d, 2024) and involves assigning trainable PEFT parameters for each task while keeping other parameters frozen. Prefix tuning (Li and Liang, 2021) is used as the PEFT module. For each task in the continuous learning sequence, a set of trainable PEFT parameters is added to the prepared machine learning model, for example a language model (PLM), i.e., a task-specific module to enable fine-tuning of the downstream task. Instead of updating the entire model, only a small number of PEFT parameters are optimized. Once training for a specific task has been completed, the corresponding PEFT module is frozen in order to retain task-specific knowledge in the subsequent training process and thus prevent catastrophic forgetting.

In a further aspect, it is proposed that the plurality of tasks and/or the input task comprises/comprise data classification and/or set classification and/or multilingual sentiment analysis and/or image classification and/or control of a technical system and/or provision of a knowledge database for controlling a technical system.

Other tasks are also conceivable, so that the list should only be considered as examples.

In another aspect, the device may be part of a control unit or units included in a vehicle with an autonomous driving function and/or a robotics system and/or an industrial machine. In other words, a control device is required that is included in a vehicle with an autonomous driving function and/or a robotics system and/or an industrial machine and that comprises a device with the features described here.

The trained machine learning model can be used, for example, as an image classifier and/or to control a technical system, in particular a robot, a vehicle with at least a partially autonomous driving function, and/or a manufacturing machine.

The described embodiments and refinements may be combined with one another as desired.

Further possible designs, refinements and implementations of the disclosure also include combinations of features of the disclosure described previously or below with regard to the exemplary embodiments that are not explicitly mentioned.

### BRIEF DESCRIPTION OF THE DRAWINGS

The accompanying drawings are intended to provide a better understanding of the embodiments of the disclosure. They illustrate embodiments and, in connection with the description, serve to explain principles and concepts of the disclosure.

Other embodiments and many of the advantages mentioned are shown in the drawings. The illustrated elements of the drawings are not necessarily shown to scale with respect to one another.

FIG. 1 shows a schematic flowchart of an exemplary embodiment.

FIG. 2 shows a schematic block diagram of an exemplary embodiment.

In the figures of the drawings, identical reference numbers denote identical or functionally identical elements, parts or components, unless stated otherwise.

### DETAILED DESCRIPTION

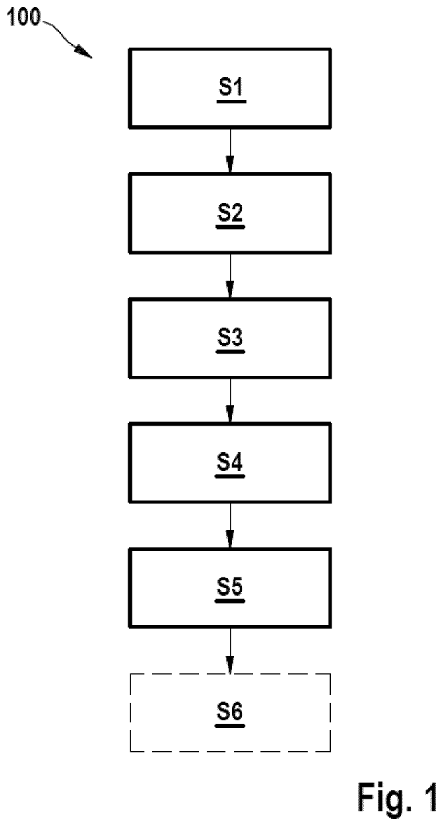

FIG. 1 shows a schematic flowchart of a method for continuously training a machine learning model, as can be performed by a device described here.

The method can be carried out in any embodiment, at least in part, by a device 100 which may comprise several components not shown in detail, for example one or more provision devices and/or at least one evaluation and computing device. It is understood that the supply device may be configured together with the evaluation and computing device or may be different from it. Furthermore, the device 100, which may be part of a system, may comprise a storage device and/or an output device and/or a display device and/or an input device.

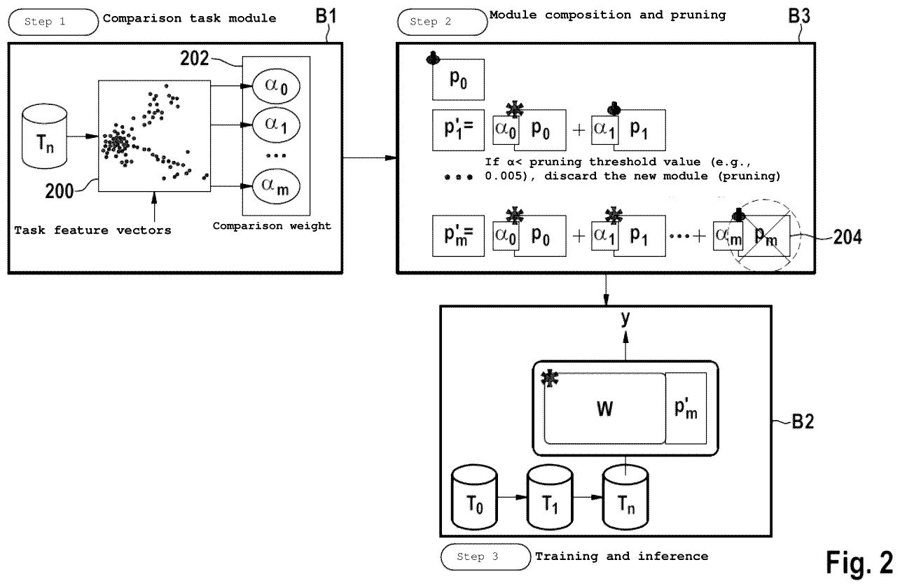

The method that can be carried out by the device described here is also explained with reference to FIG. 2. The computer-implemented method comprises at least the following steps:

In step S1, trainable task feature vectors 200, v₀ . . . vₘ₋₁ and associated, pre-known task modules P₀ . . . . Pₘ₋₁ are provided for a selection of pre-known tasks from a data pool T, which contains data on tasks that have been solved using the pre-known task modules P₀ . . . Pₘ₋₁ of the machine learning model. This is preferably done by extracting the task feature vectors v₀ . . . Vₘ₋₁ from a data pool T.

In step S2, a task input embedding xₙ, a trainable task module Pₘ with associated trainable task feature vectors 200, vₘ for a task input Tₙ to be solved are provided.

In step S3, comparison weights 202, α₁ . . . αₘ are calculated between the task input embedding (xₙ) and the trainable task feature vectors v₀ . . . vₘ to form a weighted sum P′ₘ, in particular a temporary weighted sum, from the task modules P₀ . . . Pₘ and the comparison weights α₁ . . . αₘ.

Steps S1 through S3 are summarized in FIG. 2 for block B1 (task module matching).

In step S4, the weighted sum P′m is combined with the machine learning model W.

In step S5, the machine learning model W is trained to solve the task input Tₙ by training the task feature vector vₘ and the task module Pₘ depending on a training criterion.

In step S6, it is preferable to provide the trained machine learning model y, which is supplemented by the weighted sum P′ₘ.

Steps S4 through S6 are summarized in FIG. 2 for block B2 (task module matching). Preferably, after training the machine learning model W to solve the task input Tₙ, the comparison weight αₘ of the task module Pₘ is compared with a predefined threshold value (e.g., 0.05), wherein the comparison is used to determine whether the task module Pₘ should be removed from the weighted sum p′ₘ of task modules P₀ . . . Pₘ or whether it remains in it. The removal is shown in FIG. 2 by a cross in a circle and marked with 204.

Pruning, i.e., removal or retention depending on the threshold value, is summarized in FIG. 2 for block B3 (task module matching) and is purely optional.

What is claimed is:

1. A device for training a machine learning model, wherein the device comprises an evaluation and computing device that is designed to perform the following:
providing trainable task feature vectors and associated, pre-known task modules for a selection of pre-known tasks from a data pool containing data on tasks that have been solved using the pre-known task modules of the machine learning model;
providing a task input embedding, a trainable task module with an associated trainable task feature vector for a task input to be solved;
calculating comparison weights between the task input embedding and the trainable task feature vectors to form a temporary, weighted sum, from the task modules and the comparison weights;
combining the weighted sum with the machine learning model; and
training the machine learning model to solve the task input by training the task feature vector and the task module depending on a training criterion.

2. The device according to claim 1, wherein, after training the machine learning model to solve the task input, the comparison weight of the task module is compared with a predefined threshold value, and wherein, based on the comparison, it is determined whether the task module is to be removed from the weighted sum of task modules or remains therein.

3. The device according to claim 1, wherein training the machine learning model to solve the task input includes finding the task module and the task feature vector which minimize a loss of cross-entropy of training examples and simultaneously maximize a cosine similarity between the task-specific task feature vector and the corresponding task input embedding.

4. The device according to claim 1, wherein the machine learning model comprises a language model or a convolutional neural network.

5. The device according to claim 1, wherein calculating the comparison weights comprises calculating the cosine similarity between the task input embedding and the trainable task feature vectors.

6. The device according to claim 1, wherein the task modules each have parameter-efficient fine-tuning parameters.

7. The device according to claim 1, wherein the plurality of tasks and/or the input task comprises/comprise data classification and/or set classification and/or multilingual sentiment analysis and/or image classification and/or control of a technical system and/or provision of a knowledge database for controlling a technical system.

8. The device according to claim 1, wherein the device for training the machine learning model is a device for continuously training the machine learning model.

9. The device according to claim 1. wherein the machine learning model comprises a large language model or a convolutional neural network.
